(19) United States
(12) Patent Application Publication
(10) Pub. No.: US 2025/0108933 A1
(43) Pub. Date: Apr. 3, 2025

(54) RAM AIR TURBINE STOW ACTUATION CONTROL

(71) Applicant: Hamilton Sundstrand Corporation, Charlotte, NC (US)

(72) Inventors: Anasooya Hegde, Bangalore (IN); Atul Kumar, Bangalore (IN)

(21) Appl. No.: 18/522,861

(22) Filed: Nov. 29, 2023

(30) Foreign Application Priority Data
Sep. 29, 2023 (IN) 202311065719

(51) Int. Cl. B64D 41/00

(52) U.S. Cl. CPC B64D 41/007

(57) ABSTRACT

A ram air turbine system of an aircraft includes a ram air turbine selectably movable between a stowed position and an extended position at an aircraft, and a retraction mechanism operably connected to the ram air turbine and configured to selectably move the ram air turbine from the extended position toward the stowed position. A stow panel is separate from the aircraft and is selectably connectible to the retraction mechanism. The stow panel is configured to signal the retraction mechanism to initiate movement of the ram air turbine from the extended position.

### CROSS-REFERENCE TO RELATED APPLICATIONS

This application claims the benefit of India Provisional Application No. 202311065719 filed Sep. 29, 2023, the disclosure of which is incorporated herein by reference in its entirety.

### BACKGROUND

The present disclosure relates to ram air turbine systems, and in particular to stowing of the ram air turbine in the fuselage of an aircraft after previous deployment of the ram air turbine.

In general, ram air turbine (“RAT”) systems are aircraft emergency power systems used to provide emergency electrical and/or hydraulic power to aircraft in the case of loss of both primary and secondary power sources for the aircraft. System operation can require the RAT to transition from a stowed position internal to the aircraft fuselage to a deployed position external to the aircraft fuselage. The RAT may deploy automatically in an engine failure event, or when commanded by the aircraft flight crew. Additionally, the RAT may be deployed on the ground when the system is periodically tested by maintenance personnel. The RAT typically deploys vis a spring-loaded lever and cannot be returned to the stowed position during aircraft flight. A stow mechanism is located in the fuselage and is connected to the RAT, and is activated by a switch mechanism mounted in the fuselage.

### BRIEF DESCRIPTION

In one exemplary embodiment, a ram air turbine system of an aircraft includes a ram air turbine selectably movable between a stowed position and an extended position at an aircraft, and a retraction mechanism operably connected to the ram air turbine and configured to selectably move the ram air turbine from the extended position toward the stowed position. A stow panel is separate from the aircraft and is selectably connectible to the retraction mechanism. The stow panel is configured to signal the retraction mechanism to initiate movement of the ram air turbine from the extended position.

Additionally or alternatively, in this or other embodiments the system includes a stow connector through which the stow panel is selectably connectible to the retraction mechanism. The stow connector includes an aircraft connector portion positioned at the aircraft, and a panel connector portion positioned at the stow panel and operably connectible to the aircraft connector portion.

Additionally or alternatively, in this or other embodiments the aircraft connector portion is operably connected to the retraction mechanism via a retraction lead.

Additionally or alternatively, in this or other embodiments the aircraft connector portion is located at one of an exterior surface of an aircraft fuselage or a fuselage pocket of the aircraft fuselage.

Additionally or alternatively, in this or other embodiments a connector cover is removably positioned over the aircraft connector portion.

Additionally or alternatively, in this or other embodiments the connector cover is attached to an aircraft structure using one of a cable, a string or a strap.

Additionally or alternatively, in this or other embodiments the signal is one of an electrical signal, an optical signal, or a hydraulic signal.

Additionally or alternatively, in this or other embodiments the stow panel includes at least a signal transmitter, and a switch operably connected to the signal transmitter such that when the switch is activated the signal transmitter transmits the signal.

Additionally or alternatively, in this or other embodiments the stow panel further includes a power source operably connected to the switch and the signal transmitter.

Additionally or alternatively, in this or other embodiments the ram air turbine is configured to be moved from the extended position to the stowed position.

In another exemplary embodiment, an aircraft includes an aircraft fuselage, a ram air turbine assembly located at the aircraft fuselage and selectably movable between a stowed position and an extended position, and a retraction mechanism operably connected to the ram air turbine and configured to selectably move the ram air turbine from the extended position toward the stowed position. An aircraft connector portion is located at the aircraft fuselage and is configured to be selectably connectible to a stow panel separate from the aircraft.

Additionally or alternatively, in this or other embodiments the aircraft connector portion is operably connected to the retraction mechanism via a retraction lead.

Additionally or alternatively, in this or other embodiments the aircraft connector portion is positioned at one or an exterior surface of an aircraft fuselage or a fuselage pocket of the aircraft fuselage.

Additionally or alternatively, in this or other embodiments the retraction mechanism is configured to receive a signal from the stow panel via the aircraft connector portion to initiate movement of the ram air turbine from the extended position.

Additionally or alternatively, in this or other embodiments the signal is one of an electrical signal, an optical signal, or a hydraulic signal.

Additionally or alternatively, in this or other embodiments a connector cover is removably positioned over the aircraft connector portion.

Additionally or alternatively, in this or other embodiments the connector cover is attached to an aircraft structure using one of a cable, a string or a strap.

In yet another exemplary embodiment, a method of operating a ram air turbine system of an aircraft includes connecting a stow panel separate from the aircraft to a retraction mechanism located at the aircraft and operably connected to the ram air turbine, transmitting a signal from the stow panel to the retraction mechanism via the connection, and initiating operation of the retraction mechanism in response to receiving the signal to retract the ram air turbine from the extended position toward the stowed position.

Additionally or alternatively, in this or other embodiments the stow panel is removed from connection with the retraction mechanism after the ram air turbine reaches the stowed position.

Additionally or alternatively, in this or other embodiments the signal is transmitted by activation of a switch at the stow panel.

### BRIEF DESCRIPTION OF THE DRAWINGS

The following descriptions should not be considered limiting in any way. With reference to the accompanying drawings, like elements are numbered alike:

FIG. 1 is a schematic illustration of an exemplary embodiment of a ram air turbine (RAT);

FIG. 2 is a schematic illustration of an exemplary embodiment of an aircraft;

FIG. 3 is a schematic illustration of an exemplary embodiment of a RAT stow panel connection to an aircraft;

FIG. 4 is a schematic illustration of another exemplary embodiment of a RAT stow panel connection to an aircraft; and

FIG. 5 illustrates an exemplary method of retracting a RAT.

### DETAILED DESCRIPTION

A detailed description of one or more embodiments of the disclosed apparatus and method are presented herein by way of exemplification and not limitation with reference to the figures.

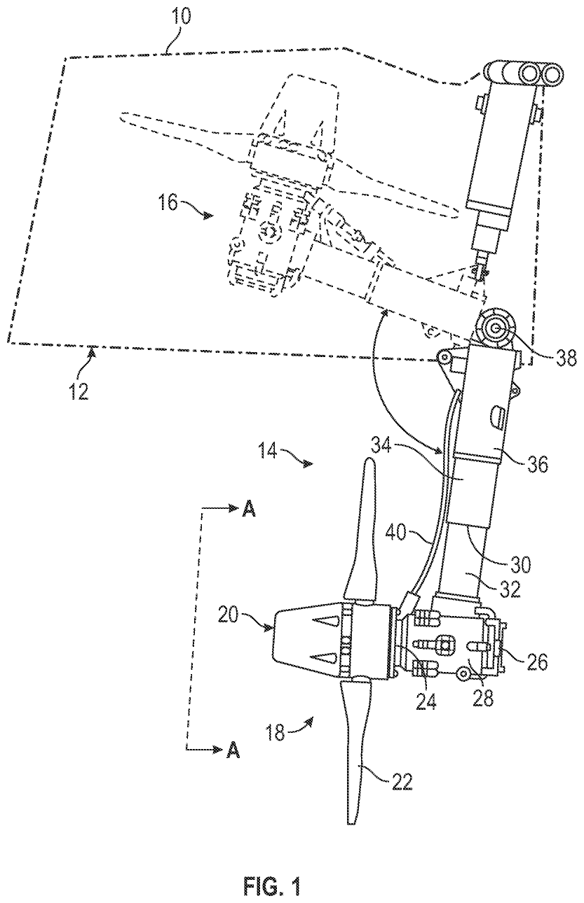

Referring now to FIG. 1, an exemplary ram air turbine (RAT) assembly 14 is illustrated. The aircraft 10 schematically shown in FIG. 1 includes an opening or a hatch 12 through which the RAT assembly 14 moves from a stowed position 16 to a deployed position 18. The RAT assembly 14 includes a turbine 20 having at least one turbine blade 22 that rotates about a turbine driveshaft 24. The turbine driveshaft 24 is coupled to a lower gear box 28 adjacent a first end 26. In the stowed position, illustrated using phantom lines, the RAT assembly 14 is disposed within the aircraft structure 10 and the turbine blades 22 are fixed in a desired orientation to prevent contact with the surrounding structure. The desired orientation of the turbine blades 22 provides for movement of the RAT assembly 14 through the opening of the aircraft structure 10.

The RAT assembly 14 also includes a strut 30 connected at a first end 32 to the turbine 20 adjacent the lower gear box 28, and coupled at a second, opposite end 34 to a generator housing 36. The generator housing 36, and therefore the strut 30 and turbine 20, is supported on the aircraft structure and is configured to rotate about a pivot 38 to provide for movement of the RAT assembly 14 between the stowed position 16 and the deployed position 18. The generator housing 36 supports a generator (not shown) that is driven by the plurality of turbine blades 22. The example generator is disposed within the generator housing 36. The turbine blades 22 rotate in response to the airstream A along the outside of the aircraft structure 10 to drive the generator. As appreciated, although the example RAT assembly 14 is disclosed with a generator, the ram air turbine 20 could also drive any other device, such as a hydraulic pump for example. The RAT assembly 14 includes a release lever 40 configured to rotate about a pivot 38 attached to the generator housing 36.

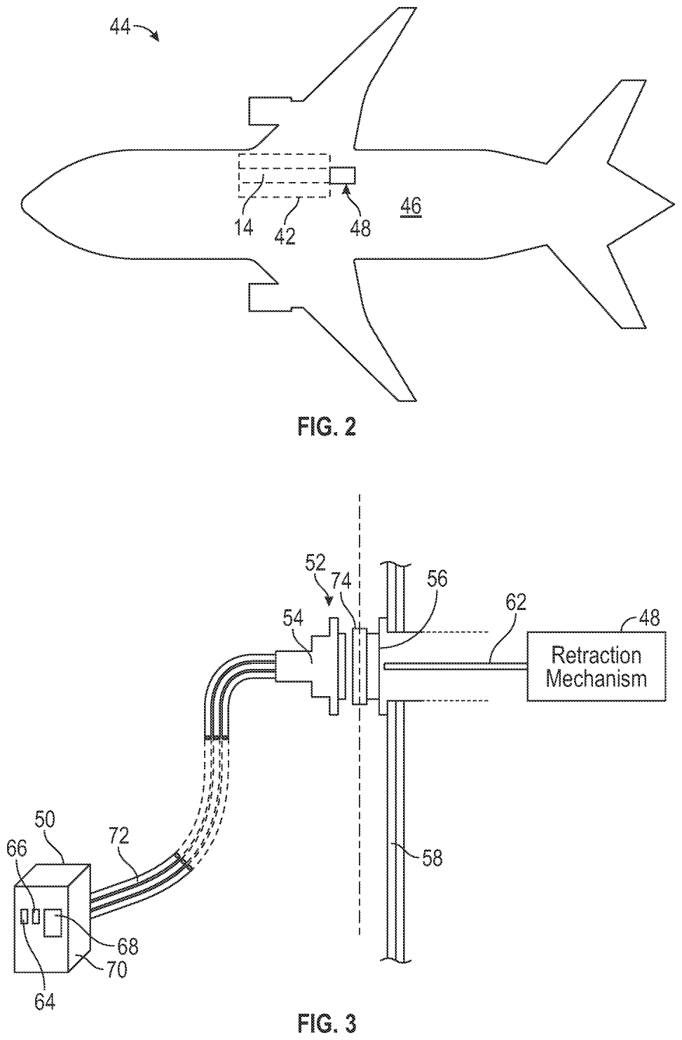

Referring now to FIG. 2, which is a schematic illustration of an embodiment of an aircraft 44, when in the stowed position the RAT assembly 14 is disposed in a RAT bay 42 of the aircraft 44, which in some embodiments is in a fuselage 46 of the aircraft 44. The RAT assembly 14 is operably connected to a retraction mechanism 48, such as a linear or rotary actuator, or the like, which is located in the fuselage 46.

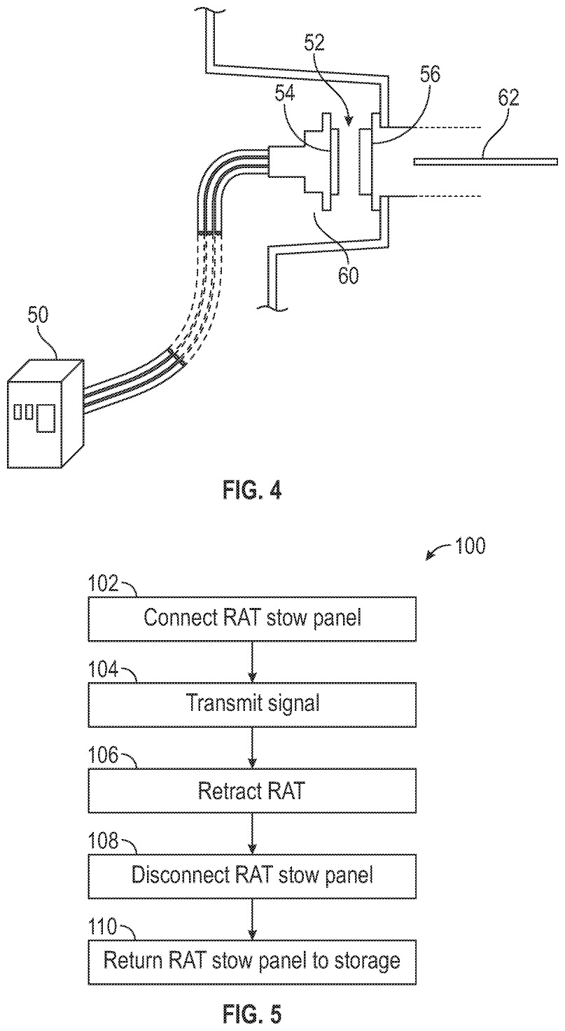

Referring now to FIG. 3, a RAT stow panel 50 is operably connected to the retraction mechanism 48 to signal the retraction mechanism 48 to retract the RAT assembly 14. The RAT stow panel 50 is a stand-alone piece of equipment not built into the aircraft 44, but is kept on the ground such in a maintenance tool storage or the like, and may be shared among several aircraft 44. When desired to retract the RAT assembly 14, the RAT stow panel 50 is operably connected to the retraction mechanism 48 via a stow connector 52, which includes a panel connector portion 54 which is part of the RAT stow panel 50. The stow connector 52 is configured to connect to an aircraft connector 56 located at the aircraft at, for example, an aircraft exterior surface 58 such as shown in FIG. 3, or alternatively recessed in a fuselage pocket 60 such as illustrated in FIG. 4. Further, in some embodiments the aircraft connector 56 is covered by a connector cover 74 to protect the aircraft connector 56 from contaminant or debris intrusion. The connector cover 74 may be attached to an aircraft structure, for example, the fuselage 46 or the aircraft connector 56 via, a cable, a string, a strap or another retention means.

Referring again to FIG. 3, the aircraft connector 56 is operably connected to the retraction mechanism 48 via a retraction lead 62 which is, for example, an electrical wire connection, a fiber optic connection or a hydraulic connection. The aircraft connector 56 is connected to the retraction mechanism 48 to transmit a retraction signal from the RAT stow panel 50 to the retraction mechanism 48 via the retraction lead 62.

The RAT stow panel 50 includes, in some embodiments, a power source 64, a signal transmitter 66 and a switch 68 contained in a panel housing 70. The switch 68 is connected to the power source 64 and the signal transmitter 66 such that when the switch 68 is activated the signal transmitter 66 transmits a stow signal along a panel lead 72 and through the stow connector 52 to the retraction mechanism 48 which then retracts or stows the RAT assembly 14 in the aircraft fuselage 46.

Referring now to FIG. 5, an exemplary method 100 of retracting a RAT assembly is illustrated. At step 102, the RAT stow panel 50 is connected to the retraction mechanism 48 via the aircraft connector 56 portion of the stow connector 52. At step 104, once connected, the RAT stow panel 50 is activated by, for example, the switch 68, and a stow signal is transmitted to the retraction mechanism 48. At step 106, once the stow signal is received at the retraction mechanism 48, the retraction mechanism 48 is activated and retracts the RAT assembly 14 into the stowed position. Once the RAT assembly 14 is retracted, the RAT stow panel 50 is then disconnected from the aircraft connector 56 at step 108, and in some embodiments is returned to maintenance tool storage or similar location at step 110.

Utilizing the stand-alone RAT stow panel 50 which is not part of the aircraft 44 is advantageous for a number of reasons including the ability to share one or two such devices among several aircraft, thus saving cost of procurement of the RAT stow panels 50. Further, removing the RAT stow panel 50 from the aircraft 44 and storing the device on the ground saves weight on the aircraft 44. Additionally, the RAT stow panel 50 may be simpler and more cost effective since airworthiness of the device is not required, and since the RAT stow panel 50 is not part of an aircraft system, the required design, development and certification effort would be reduced.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A ram air turbine system of an aircraft, comprising:
a ram air turbine selectably movable between a stowed position and an extended position at an aircraft;
a retraction mechanism operably connected to the ram air turbine and configured to selectably move the ram air turbine from the extended position toward the stowed position; and
a stow panel separate from the aircraft and selectably connectible to the retraction mechanism, the stow panel configured to signal the retraction mechanism to initiate movement of the ram air turbine from the extended position.

2. The ram air turbine system of claim 1, further comprising a stow connector through which the stow panel is selectably connectible to the retraction mechanism, the stow connector including:
an aircraft connector portion disposed at the aircraft; and
a panel connector portion disposed at the stow panel and operably connectible to the aircraft connector portion.

3. The ram air turbine system of claim 2, wherein the aircraft connector portion is operably connected to the retraction mechanism via a retraction lead.

4. The ram air turbine system of claim 2, wherein the aircraft connector portion is disposed at one of:
an exterior surface of an aircraft fuselage; or
a fuselage pocket of the aircraft fuselage.

5. The ram air turbine system of claim 2, further comprising a connector cover removably disposed over the aircraft connector portion.

6. The ram air turbine of claim 5, wherein the connector cover is attached to an aircraft structure using one of a cable, a string or a strap.

7. The ram air turbine system of claim 1, wherein the signal is one of an electrical signal, an optical signal, or a hydraulic signal.

8. The ram air turbine system of claim 1, wherein the stow panel includes at least:
a signal transmitter; and
a switch operably connected to the signal transmitter such that when the switch is activated the signal transmitter transmits the signal.

9. The ram air turbine system of claim 8, wherein the stow panel further includes a power source operably connected to the switch and the signal transmitter.

10. The ram air turbine system of claim 1, wherein the ram air turbine is configured to be moved from the extended position to the stowed position.

11. An aircraft, comprising:
an aircraft fuselage;
a ram air turbine assembly disposed at the aircraft fuselage and selectably movable between a stowed position and an extended position;
a retraction mechanism operably connected to the ram air turbine and configured to selectably move the ram air turbine from the extended position toward the stowed position; and
an aircraft connector portion disposed at the aircraft fuselage configured to be selectably connectible to a stow panel separate from the aircraft.

12. The aircraft of claim 11, wherein the aircraft connector portion is operably connected to the retraction mechanism via a retraction lead.

13. The aircraft of claim 11, wherein the aircraft connector portion is disposed at one of:
an exterior surface of an aircraft fuselage; or
a fuselage pocket of the aircraft fuselage.

14. The aircraft of claim 11, wherein the retraction mechanism is configured to receive a signal from the stow panel via the aircraft connector portion to initiate movement of the ram air turbine from the extended position.

15. The aircraft of claim 14, wherein the signal is one of an electrical signal, an optical signal, or a hydraulic signal.

16. The aircraft of claim 11, further comprising a connector cover removably disposed over the aircraft connector portion.

17. The aircraft of claim 16, wherein the connector cover is attached to an aircraft structure using one of a cable, a string or a strap.

18. A method of operating a ram air turbine system of an aircraft, comprising:
connecting a stow panel separate from the aircraft to a retraction mechanism disposed at the aircraft and operably connected to a ram air turbine;
transmitting a signal from the stow panel to the retraction mechanism via the connection; and
initiating operation of the retraction mechanism in response to receiving the signal to retract the ram air turbine from the extended position toward the stowed position.

19. The method of claim 18, further comprising removing the stow panel from connection with the retraction mechanism after the ram air turbine reaches the stowed position.

20. The method of claim 18, wherein the signal is transmitted by activation of a switch at the stow panel.
